(19) United States
(12) Patent Application Publication
(10) Pub. No.: US 2017/0341581 A1
(43) Pub. Date: Nov. 30, 2017

(54) DISPLAY DEVICE FOR SELF-PROPELLED INDUSTRIAL MACHINE

(71) Applicant: HITACHI CONSTRUCTION MACHINERY CO., LTD., Tokyo (JP)

(72) Inventors: Yoichi KOWATARI, Kasumigaura (JP); Yoshihiro INANOBE, Kasumigaura (JP); Hidefumi ISHIMOTO, Toride (JP); Yoshiyuki NAGANO, Tsukuba (JP); Masayoshi HAYASAKA, Tsukuba (JP); Eitaro ITO, Tokyo (JP); Takaaki ISHII, Kawasaki (JP); Kenta TSUKIJISHIN, Yokohama (JP)

(21) Appl. No.: 15/677,265

(22) Filed: Aug. 15, 2017

Related U.S. Application Data
(63) Continuation of application No. 14/405,490, filed on Dec. 4, 2014.

(30) Foreign Application Priority Data
Jun. 7, 2012 (JP) 2012-129511

(51) Int. Cl. B60R 1/00; G06K 9/00; H04N 7/18; E02F 9/26

(52) U.S. Cl. CPC B60R 1/00; E02F 9/26; G06K 9/00805; H04N 7/181; B60R 2300/305; B60R 2300/607; B60R 2300/105; B60R 2300/802

(57) ABSTRACT

A bird's eye view image is displayed to be recognized by an operator intuitively and precisely, irrespective of the displayed direction of the bird's eye view image. The display device has a plurality of cameras having optical axis directed obliquely downward to take images around a self-propelled industrial machine. A view point converting section converts the camera images to an upper view point to create bird's eye images, and an image composing section creates a composite bird's eye view image by composing respective bird's eye images around a symbol image of a dump truck. A direction superposing section superposes a forward direction indicator to indicate the forward direction of the dump truck on the composite bird's eye view image, and a monitor mounted in a cab of the dump truck displays the composite bird's eye image in an arbitral direction which is composited with the forward direction indicator.

### FIELD OF THE INVENTION

The present invention relates to display device for self-propelled industrial machine to assist on traveling operation of self-propelled industrial machine, such as dump truck, hydraulic excavator and the like.

### DESCRIPTION OF THE BACKGROUND ART

A self-propelled industrial machine works in various field of working sites. A dump truck is an example of the self-propelled industrial machine. The dump truck has a loading platform (vessel) adapted to move up and down on a vehicle body frame, the vessel is adapted to load substances such as crushed stones, earth and sand, etc. Then, the dump truck travels to a collection yard for the sake of discharging the loaded substances. The dump truck goes backward and is stopped at a discharging area. After completion of discharge out of the loaded substances, the vessel is returned to the original position and the dump truck is moved forward.

A hydraulic excavator is another type of the self-propelled industrial machine. The hydraulic excavator comprises a traveling base structure having a crawler-type or a wheel-type traveling means and an upper swiveling structure being rotatably placed on the traveling base structure. An operation chamber (cab) is mounted on the upper swiveling structure, and also provided on the upper swiveling structure is a working mechanism which is composed of a boom adapted to cause derricking operation to the upper swiveling mechanism, an aim being connected in vertically rotatable manner to distal end of the boom, and a bucket for digging earth and sand.

Although an operator boarded in the cab of the self-propelled industrial machine such as the dump truck or the hydraulic excavator can be attained forward view, but dead angle regions are generated on the rearward side, and left and right side views. For this reason, the operator can have an auxiliary view field around the self-propelled industrial machine by viewing a monitor which is provided in the cab, showing a bird's eye view image to position a virtual view point on the upper position. The techniques for displaying the bird's eye view image is disclosed in Patent Document 1. The techniques of the Patent Document 1 does not concern the self-propelled industrial machine, but discloses, although the techniques to display bird's eye view image around a automobile, to display a composite image consisting of CG of an automobile at the center portion and the fore, back, left and right sides on a screen.

### PRIOR ART DOCUMENT

### Patent Document

Patent Document 1: JP 2010-251939 A1

### SUMMARY OF THE INVENTION

### Problem to be Solved by the Invention

According to the techniques of the Patent Document 1, the bird's eye view image consisting of the forward, rearward, left and right sides is composited around CG of the automobile. This image is composite bird's eye view image. It is matter of course that the composite bird's eye view image should be displayed on a monitor in good condition for visibility of the operator. Therefore, the image displayed on the monitor is directed upwardly of the forward portion to the CG of the automobile positioned at the center of the composite bird's eye view image. That is to say, the composite bird's eye view image is placed vertically in the image. Thus, the operator can intuitively recognize around the automobile in view of the composite bird's eye view image displayed on the monitor.

However, the bird's eye view image is not always indicated a specific direction. The bird's eye view image may be displayed transversely on the basis of desire of operator or of the manner for display. Even though displaying the bird's eye view image in the transversal direction, the forward direction of the forward side of the vehicle can be clearly recognized in a case where the forward side of the vehicle is displayed in the CG of the automobile as shown in the Patent Document 1.

In a case of the self-propelled industrial machine, a composite bird's eye view image is also prepared by composing forward, rearward, left side and right side bird's eye images around the center position shown a symbol image represented the self-propelled industrial machine. At this time, aside from a case the centrally positioned symbol image is clearly indicated the forward side of the self-propelled industrial machine in the composite bird's eye view image, otherwise, it can hardly be recognized the forward direction of the self-propelled industrial machine at a glance when the composite bird's eye view image is shown transversely. Under such situation, an operator who is misunderstanding the direction of the self-propelled industrial machine operates it based upon the bird's eye view image, the self-propelled industrial machine is likely to run unintended direction.

The present invention has an object to be recognized intuitively and precisely direction a bird's eye view image for an operator, irrespective the direction of the representation for the direction of the bird's eye view image.

### Means for Solving the Problem

In order to solve the foregoing problem, a display device for self-propelled industrial machine of the present invention comprises: a plurality of cameras having optical axis directed to obliquely downward direction to take image around the self-propelled industrial machine; a view point converting section for converting camera images taken by respective cameras to upper view point to create bird's eye images; an image composing section to create composite bird's eye view image by composing respective bird's eye images around a symbol image to be symbolized the self-propelled industrial machine; a direction superposing section to superpose forward direction indicator to indicate forward direction of the self-propelled industrial machine on the composite bird's eye view image; and a monitor mounted in a operator's cab of the self-propelled industrial machine for displaying the composite bird's eye image in an arbitral direction which is composited with the forward direction indicator.

According to the present invention, the forward direction indicator is superposed on the symbol image to indicate forward direction. By indicating the forward direction, the operator can recognize intuitively and precisely the forward direction of the self-propelled industrial machine, even if the direction of the composite bird's eye view image is not settled specific direction.

In a case of the display device is a laterally long screen and the composite bird's eye view image is longer in transversal direction, the composite bird's eye view image may be displayed on the screen directed to transversal direction.

In a case of the composite bird's eye view image is laterally long to display a transversally long screen, the screen cannot be utilized effectively due to unable to widely on the displaying area. For this reason, when the composite bird's eye view image is shown transversal direction, the composite bird's eye view image can be displayed in large size by effectively utilized the screen. In this situation, the operator can intuitively and precisely recognize the forward direction of the self-propelled industrial machine in light of the forward direction indicator.

Further, the screen is adapted to change over between first display mode for displaying the bird's eye image in the form of transversal direction and second display mode to divide transversally into two parts, wherein on one part showing the composite bird's eye view image and on the other part showing the camera image without view point conversion.

In accordance with the first display mode, the composite bird's eye view image can be displayed in a large size, thus the visibility of the composite bird's eye image may be improved for the sake of recognition. While, in a case of the second display mode which is displayed a composite bird's eye view image and a camera image simultaneously, sufficient information are given at the traveling operation by directly visible of the camera image, though more or less the deteriorating the visibility of the composite bird's eye view image.

And in response to information from a traveling operation mechanism for operating to travel the self-propelled industrial machine, the travel direction indicator may be so designed as to superpose on the symbol image at the time of performing travel by the operation, but may not be indicted a travel direction indicator at the time of being stopped the traveling operation

The self-propelled industrial machine can be intuitively and precisely recognized in view of the forward direction indicator, further in addition to the forward direction and the traveling direction can intuitively and precisely be recognized by displaying a traveling direction indicator.

And the direction superposing section may compose the forward direction indication on the position of the cab in the symbol image.

An operator operates the self-propelled industrial machine in the boarded cab. Accordingly, the forward direction of the self-propelled industrial machine is clearly understood directly by indicating the forward direction indicator on the position of the cab.

Further, in accordance with the direction superposing section, the forward direction indicator may be displayed with a different color from the symbol image.

the forward direction indicator may not be clearly seen in a case of displayed in the same color as the symbol image. Accordingly, the forward direction can clearly be recognized to the operator by showing them with different color.

### Effects of the Invention

According to the present invention, a forward direction indicator is composed on a symbol image to indicate forward direction. An operator can recognize intuitively and precisely forward direction of a self-propelled industrial machine, even if shown a composite bird's eye view image facing in any direction.

### BRIEF DESCRIPTION OF THE DRAWINGS

FIG. 1 is a left side elevation view of a dump truck.

FIG. 2 is a plane view of the dump truck.

FIG. 3 is a drawing of an example of a monitor to be mounted in a cab.

FIG. 4 is a drawing of another example of a monitor to be mounted in a cab.

FIG. 5 shows a block diagram of a display controller.

FIG. 6 is a principle explanation for processing a view point conversion.

FIG. 7 shows an example showing display of a composite bird's eye view image shown on a monitor screen.

FIG. 8 is an example of display image in the second display mode.

FIG. 9 shows another example of FIG. 7.

FIG. 10 shows differentiate the boundary line.

FIG. 11A shows an indication of travel direction icon on forward position of shift lever.

FIG. 11B shows an indication of travel direction icon on stop position of shift lever.

FIG. 11C shows an indication of travel direction icon on rearward position of shift lever.

FIG. 12 shows indication of another type travel direction icon.

### EMBODIMENT OF THE INVENTION

Hereafter, embodiments of the present invention will be described with reference to drawings. As self-propelled industrial machine, carrier vehicle, construction machine, roadwork vehicle and the like are included, a dump truck is a typical carrier machine and a hydraulic excavator is a typical construction machine. In this embodiment, a dump truck is applied for explanation, but the other self-propelled industrial machine may be applied other than the dump truck. The dump truck 1 includes a rigid type and an articulated type, any type can be applied. In the embodiment, “left” means the left side view from an operator's cab, and “right” means the right side view from the operator's cab.

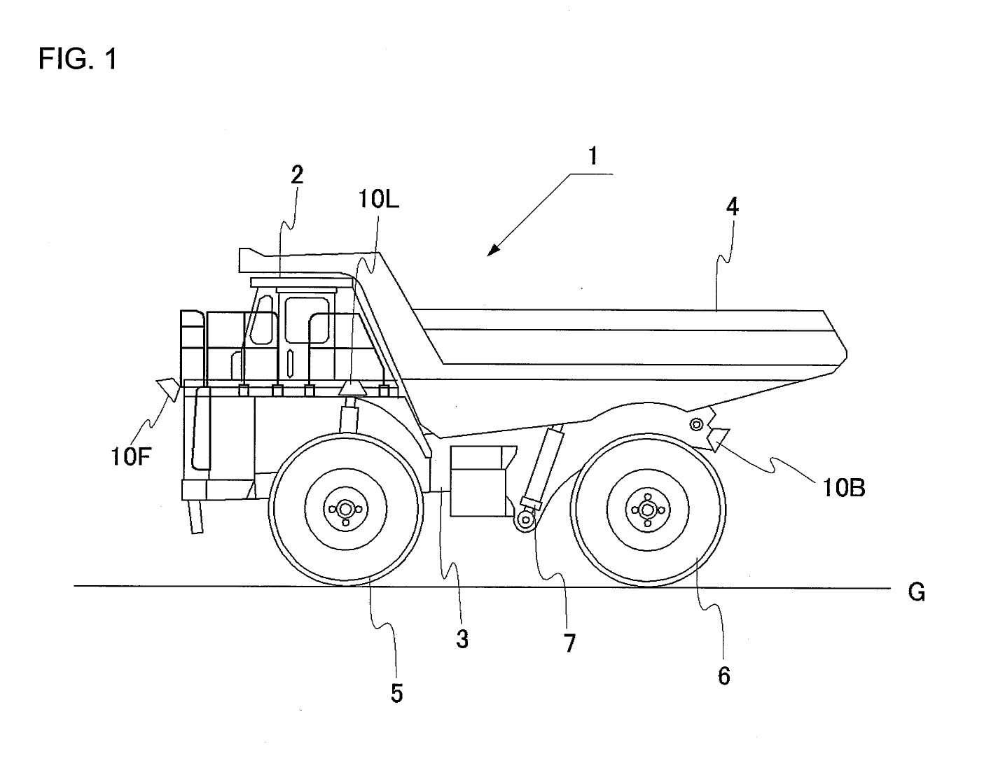

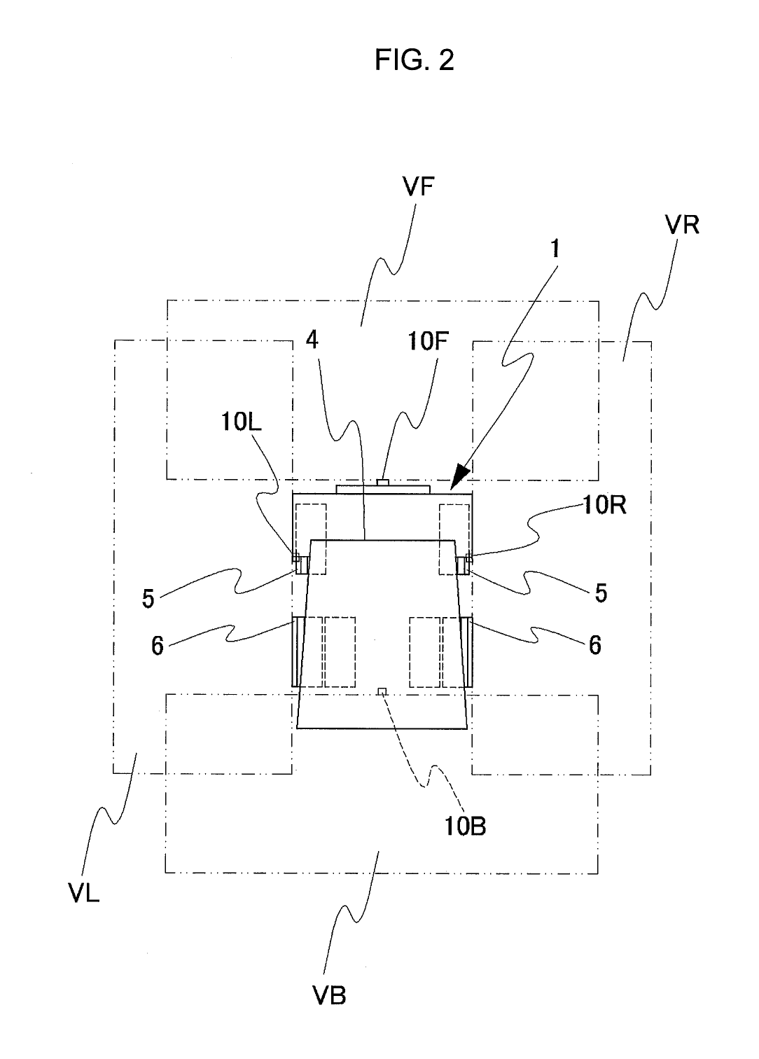

FIG. 1 shows the left side elevation of the dump truck 1 and FIG. 2 shows the plan view thereof. As shown in these drawings, the dump truck 1 comprises a cab 2, a frame 3, a vessel 4, front wheels 5 and rear wheels 6, a driving cylinder 7 and a link mechanism 8. The forward side, rearward side, left side and right sides of the dump truck 1 are provided with cameras 10 (forward side camera 10F, right side camera 10R, left side camera 10L and rearward side camera 10B), and images taken by respective cameras are outputted as camera images.

The forward side camera 10F has a field of view toward the forward side, the rearward side camera 10B has a field of view toward the backward side, the right side camera 10R has a field of view toward the right side and the left side camera 10R has a field of view toward the left side. In FIG. 2, phantom lines are indicated respectively for the view area of the forward side camera 10F as a forward view region VF, for the view area of the rearward side camera 10B as a backward view region VB, for the view area of the right side camera 10R as a left side view region VL and for the view area of the right side camera 10L as a right side view region VR. These view regions are exemplified as rectangular form, but not restricted to be rectangular form.

These cameras take image around the dump truck 1 and these cameras are directed obliquely downward direction. In this connection, number of cameras 10 may be arbitrary to be mounted on the dump truck 1. While, it is desired to provide that the rearward side camera 10B, the right side camera 10R and the left side camera 10L are mounted at respective positions toward the directions possibly causing dead angle for the operator. In a case of an articulated type dump truck, further more cameras may be provided.

A cab 2 is provided for boarding the operator to operate the dump truck 1 which is normally placed at the left side at the dump truck 1. Various operating means are arranged in the cab 2. The frame 3 constitutes a truck frame, the front wheel 5 is provided at the fore side of the frame 3 and the rear wheel 6 is provided at the rearward side thereof. The vessel 4 is a platform which is loaded with earth and sand, ore or the like. The vessel 4 is connected to the driving cylinder 7 and the link mechanism 8 for tilting action. Thereby, loaded earth and sand or the like is discharged out from the vessel 4.

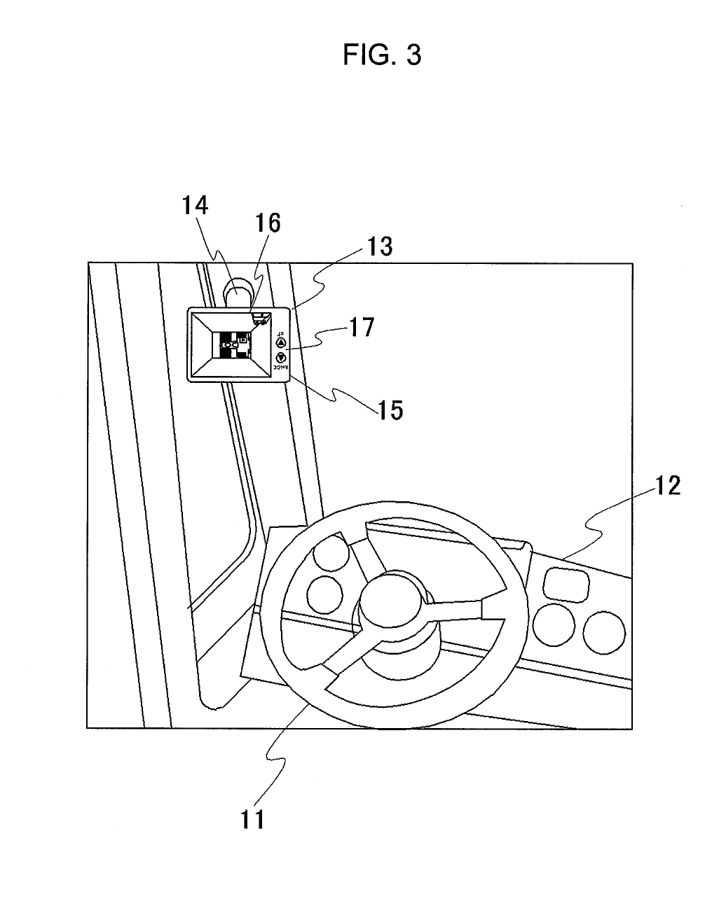

FIG. 3 shows an example of the cab 2. A handle 11 for performing operation of the driving direction, and indicators for various meters are provided on a consol 12, further pillars 13 are installed in the cab 2. In addition, an installation mount 14 is rotatably installed to one pillar 13, a monitor 15 being installed to the installation mount 14. The installation mount 14 may be constituted by a flexible joint mechanism, a hinge mechanism or the like, thus the monitor 15 is adapted to cause rotation.

The monitor 15 is a display device consisting of a screen 16 and an input part 17, having vertically longer aspect ratio than transversal direction (that is, the number of pixel being larger in transversal direction than lateral direction). In short, the screen 16 is laterally long display. The input part 17 is provided for operation to control contents in the displayed screen 16. Further, the monitor 14 is provided arbitral position within the cab 2. Further, the screen 16 may be constituted as a touch panel so as to eliminate the input part 17.

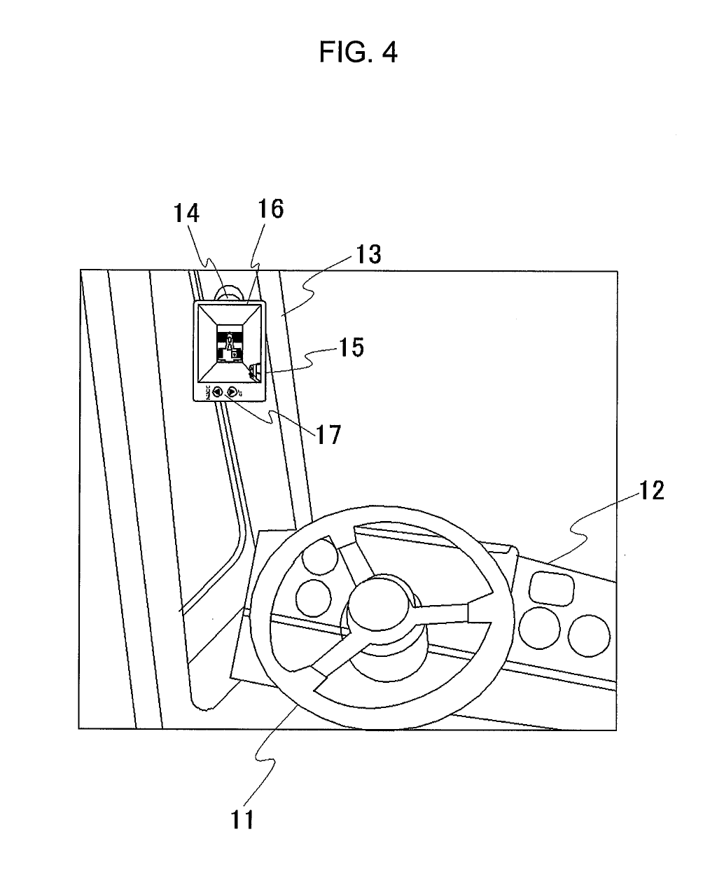

The monitor 15 is attached to the installation mount 14 and adapted to make rotation. FIG. 4 shows the monitor 15 rotated at 90 degree from the state of FIG. 4. In this case, although the aspect ratio of the screen 16 is not changed, the operator can see the screen 16 in transversely long screen. Accordingly, the operator can select arbitrary to display the FIG. 3 screen or FIG. 4 screen at will. In this connection, the direction of the monitor 15 may be settled in advance, by the installation mount 14 stands stationary.

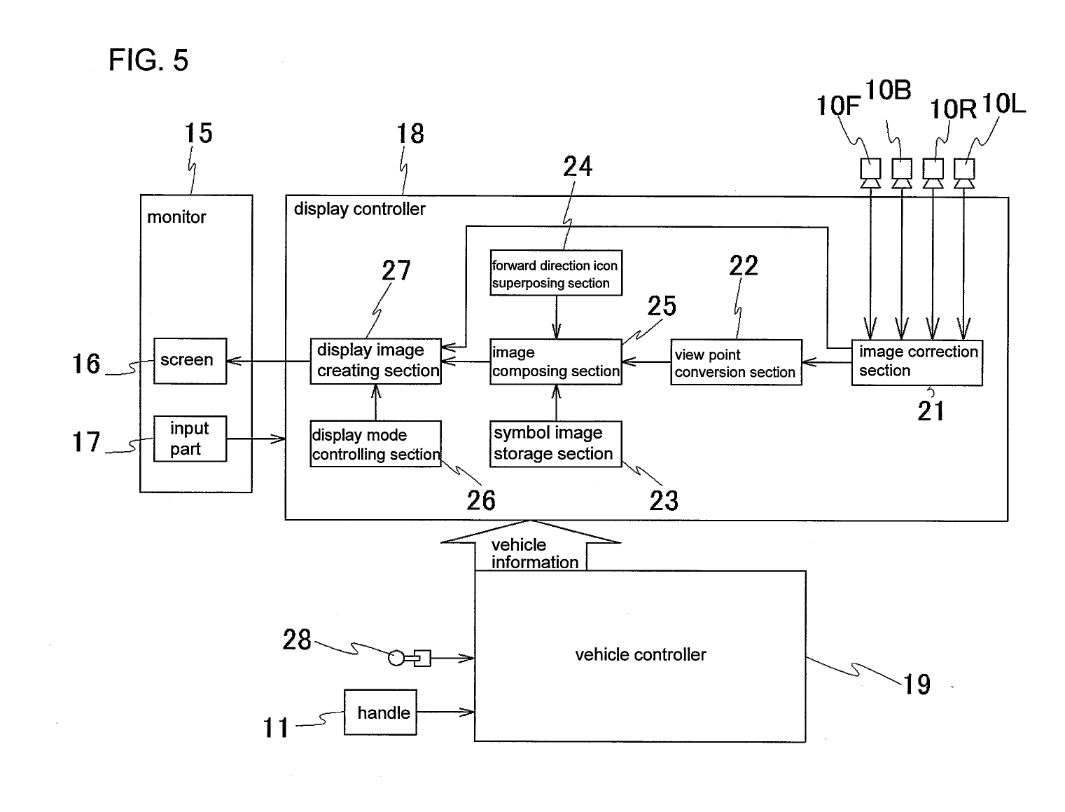

FIG. 5 shows a display controller 18 connected to the monitor 14 and a vehicle controller 19 connected to the display controller 18. As shown in this figure, the display controller 18 comprises an image correction section 21, a view point conversion section 22, a symbol image storage section 23, a forward direction icon composing section 24, an image composing section 25, a display mode controlling section 26 and a display image creating section 27. The respective sections of the display controller 18 may be achieved by a software and the functions of the respective section on the basis of CPU.

The image correction section 21 is inputted image data (through image) from the forward side camera 10F, the rearward side camera 10B, the right side camera 10R and the left side camera 10L. And, the inputted image data are subjected to perform various image corrections such as lens distortion correction, aberration correction, contrast correction, color tone correction and so on based upon parameters for camera optical system and the like. Thereby, the inputted image can be improved the image quality. The corrected image in the image correction section 21 is inputted to the view point correction section 22 as an image data to be subjected for conversion.

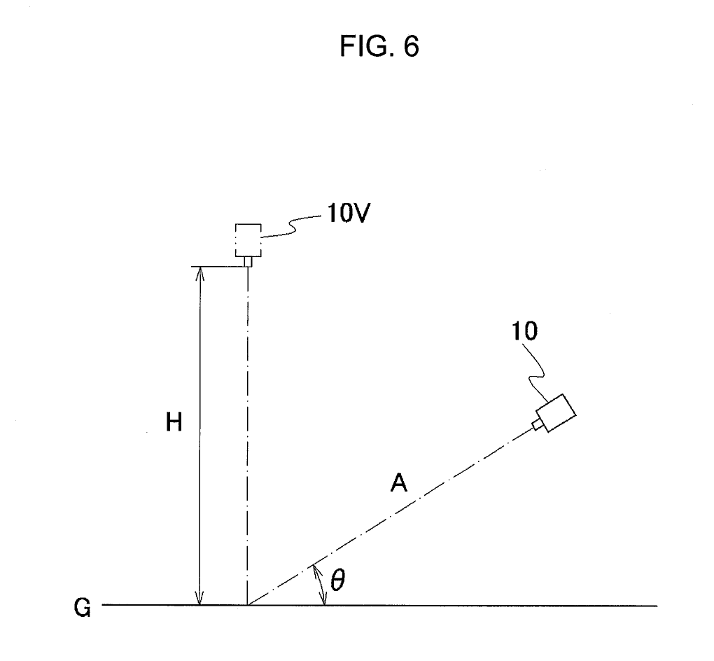

The view point conversion section 22 performs a process for the view point conversion for the image data which is fetched from the image correction section 21 to create bird's eye view image (virtual view point image). As previously described, respective cameras 10 which are directed the optical axis to obliquely downwardly are converted to virtual view point from upper position to downwardly. As shown in FIG. 6, the optical axis A of objective lens of cameras 10 (forward side camera 10F, right side camera 10R, left side camera 10L and rearward side camera 10B) have a predetermined angle θ with respect to the grand lever L, therefore the optical axis of the cameras 10 are directed obliquely downwardly. According to the view point conversion section 22, virtual camera 10V is virtually set at height H with the vertical optical axis, and the coordinate is converted to view from the virtual camera 10V to the ground surface G. The image which is converted to the upper view point is virtual plan view (bird's eye view image).

Accordingly, the image taken from the forward side camera 10F is created the forward side bird's eye view image, the image taken from the rearward side camera 10B is created the rearward side bird's eye view image, the image taken from the right side camera 10R is created the right side bird's eye view image and the image taken from the left side camera 10L is created the left side bird's eye view image. In this connection, as already explained, the number of cameras consisting of the cameras 10 is not restricted, the number of bird's eye images created is also changed in accordance with the number of cameras. However, it is preferred that three bird's eye images consisting of the forward, left and right side bird's eye images are necessarily created due to generating dead angles of the operator.

The symbol image storage section 23 has a symbol image data. The symbol image is an image of the dump truck 1 to display on the screen 16 as a symbol (character). That is, the symbol image is the reproduction image of the dump truck 1. By making high reproducibility, the operator can exactly recognize the feature of the dump truck 1. However, the reproducibility of the dump truck is not essentially necessary factor. As a diagram or the like can be used as the symbol image provided that the image is capable of being recognized as a dump truck 1.

The forward direction icon composing section 24 which has a function of the forward direction indication superposing part stores a forward direction icon to indicate the forward direction of the dump truck 1. The stored forward direction icon which denotes forward direction indicator is processed to be composed on the symbol image. Since the symbol image represents the contour of the dump truck 1, the forward direction icon is composed on the position of the cab. Although the icon is superposed on the cab, the position of the forward direction icon can be placed on an arbitrary position in the symbol image.

The superposing process section 25 is inputted of respective bird's eye image data converted view point from the view point converting section 22 and of the symbol image data from the symbol image storage section 23. And an image composition process is performed to dispose the symbol image at the center position and respective bird's eye images being arranged around it. Each component composes the symbol image in the center, and around there, being composed of the fore side bird's eye image at the forward side position, the rearward side bird's eye image at the rearward side position, the right side bird's image at the right side position and the left side bird's eye image at the left side position, respectively.

Shown in the symbol image is adopted as an configuration of a rectangular shape, and four boundary lines are formed from the four corners to define the regions to display respective bird's eye images. The four boundary lines are formed radially from the symbol image region. These boundary lines and the area to display the symbol image defines the regions to display respective bird's eye images. The image composing section 25 performs process to compose respective bird's eye image to the thus defined four regions. Thus processed composite image is a composite bird’ eye view image, consisting of the symbol image at the center position and surrounding thereof forward side bird's eye image at the forward side position, the rearward side bird's eye image at the rearward side position, the right side bird's image at the right side position and the left side bird's eye image at the left side position.

The display mode controlling section 26 is adapted to control the display mode of the image on the screen 16. The screen 16 can display the composite bird's eye view image toward arbitral direction, or the screen 16 may be divided into two parts in order to display the composite bird's eye view image for one part, while to display a camera image for the other part. Accordingly, the display mode can be changed, and the display mode controlling section 26 controls to change over thereof.

The display image creating section 27 is inputted the composite bird's eye view image created in the image composing section 25 and camera image corrected in the image correction section 21, and creates display image to be displayed on the screen 16. For this purpose, the display mode controlling section 26 is provided for the sake whichever mode is adopted to display. In the embodiment of the invention, mode adapted to change is adapted to enter either into first display mode or into second display mode. The display image created by the display image creating section 27 is outputted to the screen 16 for displaying on the screen 16.

As shown in FIG. 5, the display controller 18 is connected to the vehicle controller 19. The vehicle controller 19 is connected to various operating means for controlling the dump truck 1. A shift lever 28 is one means to be connected thereto. The shift lever 28 is a travel operating means to control the travel of the dump truck 1, and is adapted to shift three positions of forward position, neutral position and rearward position. At the time of the shift lever 28 placed at the forward position, the dump truck 1 runs forward direction, while at the rearward position, the dump truck 1 running backward direction and at the neutral position, the dump truck 1 being stopped. The shift lever information as to the status of the position of the shift lever 28 (forward, neutral or rearward) is outputted to the vehicle controller 19. Further, the shift lever information is transferred to the display controller 18 as a vehicle information.

Further, steering information is inputted to the vehicle controller 19 from the handle 11. The dump truck 1 is change the course toward left or right by operating the handle 11, thus being operated the handle 11 is inputted to the vehicle controller 19 as steering information. Thereby, the vehicle controller 19 being recognized the traveling direction angle.

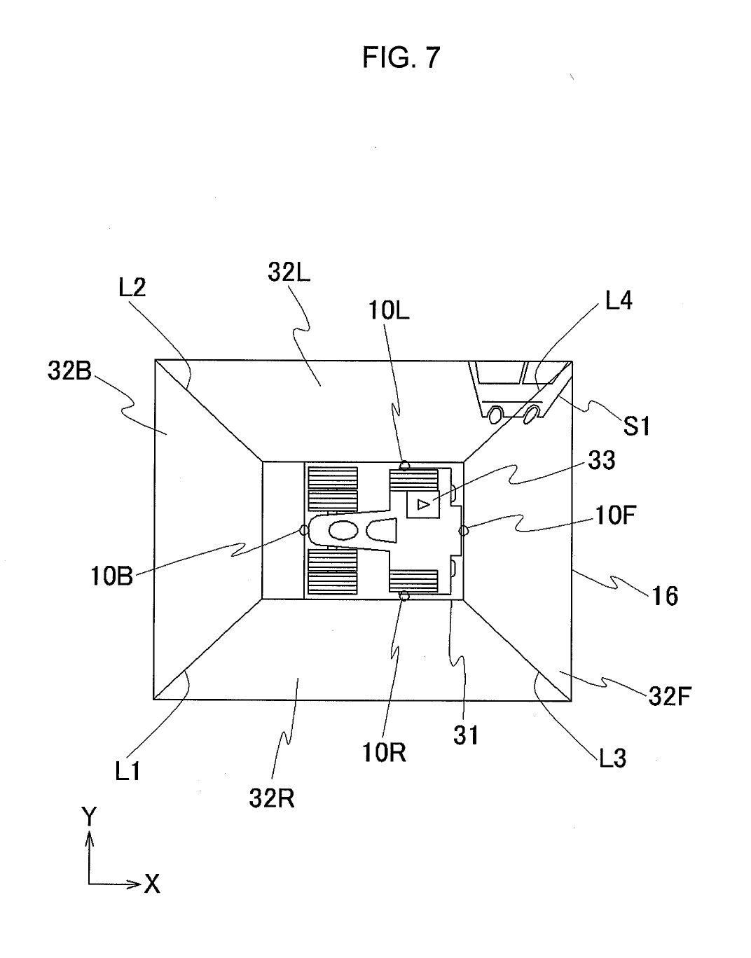

According to the construction thus explained, the display controller 18 prepares the displaying image on the screen 16 of the monitor 15. FIG. 7 shows an example of installed the monitor 15 in the situation of FIG. 3. In a case using a generic liquid crystal display or the like, aspect ratio of the screen 16 is larger in the transversal direction than the vertical direction. In other words, a screen is used having aspect ratio X:Y is 4:3 or 16:9, wherein X is transversal direction and Y is vertical direction. In this connection, depending upon the monitor 15 being installed as shown in FIG. 3 or as shown in FIG. 4, appearance to be seen by the operator is differed in a transversally long screed or vertically long screen, while aspect ratio of the screen remains unchanged. Hereinafter, explanation is made for the case where the monitor 15 is installed as shown in FIG. 3.

For the sake of displaying image on the screen 16 of the monitor 15, respective cameras 10 are performed to take image. To this end, an operator performs to start engine, thereby respective cameras 10 being started to take image. As mentioned in foregoing, respective cameras are taken images obliquely downwardly, the forward side camera 10F imaging obliquely downward in forward direction, the rearward side camera 10B imaging obliquely downward in rearward direction, the right side camera 10R imaging obliquely downward in rightward direction and the left side camera 10L imaging obliquely downward in left direction.

The image data from these cameras 10 are outputted (are transferred) to the display controller 18 as camera images. The cameras 10 are taking image continuously at a predetermined cycle and are transferred camera images at every imaging cycle. Thereby, video image is displayed on the screen 16. In this connection, still image may also be displayed.

As shown in FIG. 5, the image correction section 21 performs predetermined correction process to the image data outputted from the cameras 10. Thereby, the quality of the image data can be improved. The image data completed the correction process are subjected to convert the view point in the view point conversion section 22. The image taken from the fore side camera 10F is created the fore side bird's eye view image 32F, the image taken from the rearward side camera 10B is created the rearward side bird's eye view image 32B, the image taken from the right side camera 10R is created the right side bird's eye view image 32R and the image taken from the left side camera 10L is created the left side bird's eye view image 32 L. Thus created bird's eye view images 32 are outputted to the image composing section 32.

The image composing section 25 is acquired symbol image 31 as shown in FIG. 7 from the symbol image storage section 23. The symbol image 31 is placed in the center position of the screen 16. In this connection, the dump truck 1 has a generally rectangular configuration view from upper, thus the dump truck 1 is hardly recognized of the forward direction from the symbol image 31. Further, the dump truck 1 has longer length in transversal direction than width direction. Accordingly, the symbol image 31 represented the dump truck 1 is longer in the longitudinal direction than in the width direction.

As explained, aspect ratio of the screen 16 is longer in transverse direction than vertical direction. Accordingly, the symbol image should be placed the longitudinal direction toward X direction and width direction toward Y direction. Thereby, the symbol image in the screen 16 has aspect ratio in the transversal direction larger than the vertical direction. This means that the direction of display is determined in the symbol image 31 in accordance with the aspect ratio. Accordingly, the longitudinal direction of the symbol image 31 is directed to X direction, and naturally the fore direction of the dump truck 1 becomes X direction.

The image composing section 24 is attained symbol image 31 from the symbol image storage section 23 to arrange, as already explained, the center position of the screen 16. Simultaneously, the forward side bird's eye image 32F is placed in the region between boundary lines L3 and L4, the right side bird's eye image 32R is placed in the region between boundary lines L1 and L3, the rearward side bird's eye image 32B is placed in the region between boundary lines L2 and L4 and the left side bird's eye image 32L is placed in the region between boundary lines L1 and L2. Thereby, composite bird's eye view image is created as shown in FIG. 7. The composite bird's eye view image is a so called a composite bird's eye view image representation.

The composite bird's eye view image may be displayed on the full area of the screen 16. Accordingly, the composite bird's eye view image is displayed as large as possible. Therefore, the screen 16 has aspect ratio greater in X direction than Y direction, symbol image 31 being displayed to place longitudinal direction in X direction and width direction in Y direction. As a result, composite bird's eye view image is able to display widely, thereby the operator can survey effectively the surrounding situation of the dump truck 1.

As explained above, the symbol image 31 is placed longitudinal direction toward X direction. Accordingly, at the time of viewing the screen 16, the operator is liable to recognize the forward direction of the symbol image 31 in a case of being directed toward Y direction or transversal direction. However, when the forward direction of the symbol image 31 is directed to X direction or vertical direction, the recognition of the forward direction of the symbol image 31 is encounter difficulty. Thereby, operator confuses in thought which is the forward direction of the dump truck 1, as a result the bringing into misunderstanding of the forward direction of the dump truck 1 for the operator

Accordingly, the forward icon composing section 24 composes a forward direction icon 33 on the symbol image 31. The forward direction icon 33 is an index of the forward direction of the symbol image 31 to direct the forward direction as a triangle mark shown in FIG. 7. That is, the direction of apex of the triangle involves the forward direction. The operator can recognize the forward direction of the symbol image 31 at a glance by viewing the forward direction icon 33, even though the X direction is directed for the forward direction of the symbol image 31. Thereby, the operator can recognize precisely and intituitively with the direction of the composite bird's eye view image.

The image composing section 25 is outputted to the display image creating section 27 the composite bird's eye view image consisting of the symbol image 31 and the forward direction icon 33 composed thereon. The display mode controlling section 26 is adopted first display mode in FIG. 7 which is the composite bird's eye view image displayed widely. The display image creating section 27 performs the composite bird's eye view image as a displaying image output to the screen 16 upon recognition that the first display mode is selected in the display mode controlling section 26. As a result, the screen 16 shows the display image (composite bird's eye view image) as the bird's eye image shown in FIG. 7.

In accordance of displaying the bird's eye image shown in FIG. 7, the operator can recognize approaching a obstacle S1 of a service car. The operator can recognize clearly the positioning relationship between the dump truck 1 and the obstacle S1 by reviewing the bird's eye view image displayed on the screen 16. Under the situation approaching the obstacle S1 as FIG. 7, the operator can recognize to bring about collision the dump truck 1 with the obstacle S1, if the dump truck 1 is moving to forward toward leftward.

Under the foregoing situation, the operator performs to drive with misunderstanding of the forward direction of the symbol image 31, the dump truck 1 could be possible to move toward the obstacle S1. However, due to the forward direction icon 33 is indicated on the symbol image 31, the direction of the dump truck 1 to be driven can precisely and intuitively be recognized with reference to view the forward direction icon 33, thereby the dump truck 1 being avoided to move toward obstacle S1.

The first display mode mentioned above can be utilized the display area of the screen 16 widely, thus the composite bird's eye view image being adapted to display its full range or almost full range. By displaying the composite bird's eye view image widely, the operator can observe the situation of the surroundings of the dump truck 1 in detail. Accordingly, although the front end of symbol image 31 is directed to X direction, the operator can recognize the direction certainly and intuitively by way of composited the forward direction icon 33.

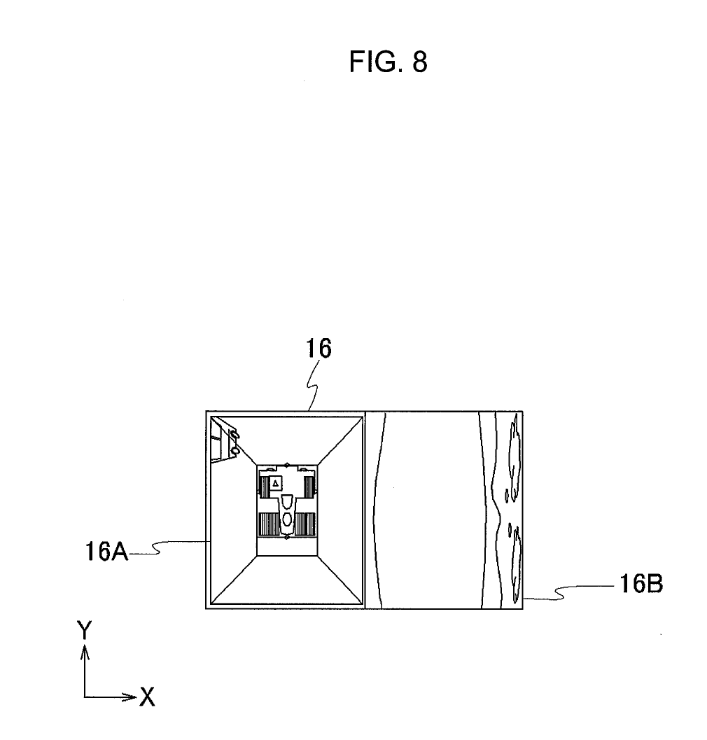

In the next place, explanation is made for the second display mode. FIG. 8 shows an embodiment of the second display mode. The display mode controlling section 26 is adapted to select the second display mode. Manner of the selection between first display mode or second display mode may be set appropriately. For example, the operator can perform input operation by using the input part 17, or the representation is adapted to automatically switch at a predetermined time period between the first display mode and the second display mode. Needless to say, an arbitral display mode can be entered to be controlled other than the first display mode and other than the second display mode.

As shown in FIG. 8, the screen 16 is divided equally transversally (X direction) into first display region 16A and second display region 16B. The composite bird's eye view image is shown in the first display region 16A, while camera image is shown in the second display region 16B. The camera image shown in the second display region 16B is image taken by the camera 10, that is image before view point conversion process of the view point converting section 22. As far as the camera image, whichever camera 10 may be selected, while it is preferred to be a rearward camera image, that is the rearward side camera 10B, which is dead angle in most part thereof for the operator. The camera image to be displayed is preferred after being completed correction process in the image correction section 21.

The display image creating section 27 is obtained rearward camera image from the image correction section 21 and composite bird's eye view image from the image composing section 25. Then, composite bird's eye view image is shown in the first display region 16A and camera image is shown on the second display region 16B. While, composite bird's eye view image may be shown in the second display region 16B and camera image may be shown on the first display region 16A.

As explained, composite bird's eye view image is shown in the first display region 16A, the displayed bird's eye view image is rotated 90 degree from the status of FIG. 7. That is, the direction of the symbol image 31 is transversal direction toward Y direction and vertical direction toward X direction. The screen 16 has aspect ratio of longer in transversal direction than the vertical direction, while aspect ratio of the first display region 16A has longer size in vertical direction than transversal direction. For this reason, on displaying bird's eye view image, bird's eye view image is rotated to shift figure of front to back direction to Y direction and to the up to down direction to X direction.

And, since the first display region 16A has an area of half size in the screen 16 of FIG. 7, composite bird's eye view image is decreased in size and the reduced composite bird's eye view image is displayed in the first display region 16A. In addition, rearward camera image is shown in the second display region 16B. Thereby, the display contents is shown in FIG. 8.

Due to composite bird's eye view image is reduced in size, the visibility deteriorates in comparison with the displaying the composite bird's eye view image in full screen 16 as shown in FIG. 6. In this connection, the most of rearward direction of the dump truck 1 is dead angle for the operator, confirmation in visibility has difficulty at the rearward direction, thus details of the rearward situation can be known by displaying the rearward side camera image, even though more or less deterioration is brought in visibility of composite bird's eye view image in comparison with the first display mode. By displaying composite bird’ eye view image and rearward camera image side by side, the surrounding situation of the dump truck 1 can be recognized together with the rearward situation in detail.

Incidentally, the symbol image 31 directed ahead Y direction in the second display mode. The direction is naturally for the operator so that misunderstanding the forward direction of the dump truck 1 is hardly be occurred. In this situation, the forward direction icon 33 may be omitted from the composition on the symbol image 31.

However, the first display mode and the second display mode are constructed adapted to change over each other, the forward direction of the symbol image 31 is directed to X direction in the case of the second display mode, while the forward direction in the symbol image 31 being directed to Y direction. That is, upon changing over the display image, the forward direction of the symbol image 31 becomes to be changed. For this reason, the forward direction icon 33 is superposed in the second display mode, even in a case of composite bird's eye view image is displayed naturally visible for the operator. Thereby, the forward direction of the symbol image 31 is further clearly recognized to the operator.

Further, the screen 16 is equally divided to first display mode and second display mode, but equality is not essential factor. In addition, division number of the screen 16 may be three or more, even though division number is two in the embodiment. However, a monitor 15 installed in the cab 2 of the dump truck 1 has a small size so as not to impede the forward visual field to the operator. Accordingly, if the screen 16 is increased division number not so large in size, extremely small image for respective regions, resulting to reducing the visibility. Taking into consideration of the foregoing, the division number is preferable to two regions, the division number being four or less at best.

According to the first display mode, the screen 16 is used for bird's eye image displaying area widely to show composite bird's eye view image in large size, the situation surrounding the dump truck 1 is recognized to the operator in details. Although the forward direction of the symbol image 31 is directed to X direction, the operator can precisely and intuitively recognize the direction by means of the forward direction icon 33.

While, in the second display mode which shows composite bird's eye view image and camera image simultaneously, the visibility of composite bird's eye view image is deteriorated in comparison with the first display mode, rearward situation which includes dead angle of most field of view can be recognized in details. It is convenient to change over between the first display mode and the second display mode, thereby bringing in an appropriate manner to be best use for displaying image on the screen 16.

Under the foregoing situation, the forward direction icon 33 is preferably positioned at the cab 2 in the symbol image 31 by means of the forward direction icon composing section 24. Since the operator is boarded in the cab 2 to operate the dump truck 1, the forward direction icon 33 positioned on the cab is feasible for the operator to further intuitively recognize the forward direction of the dump truck 1. Although the forward direction icon is preferably composed on the position of the cab 2, the position is not limited but may be positioned arbitrary within the symbol image 33. In other words, the position is optionally set, provided the operator can recognize the forward direction of the symbol image 31 intitutively and precisely.

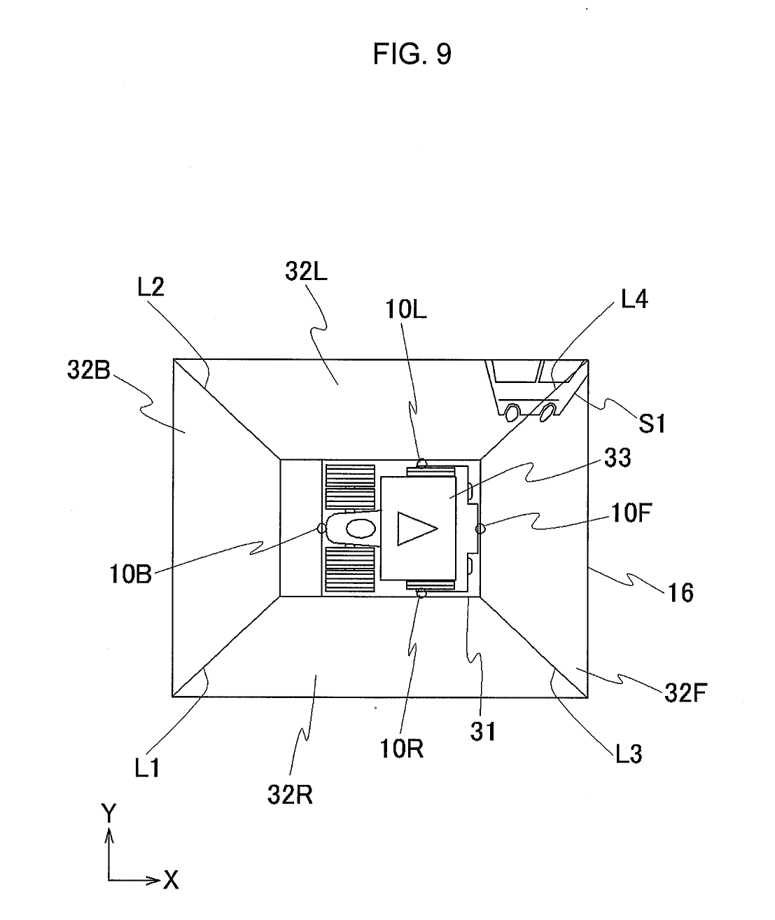

To this end, the forward direction icon 33 may be represented large in size as shown in FIG. 9 for displaying the forward direction of the symbol image 31 more clearly. However, the symbol image 31 is a reproduction of a contour of the dump truck 1, and the bird's eye view image representation is adapted to show the relationship between the dump truck 1 and the surrounding situation. Thus accordingly, it is preferred that the magnified forward direction icon 22 should be suppressed within the contour of the symbol image 31.

Further, the symbol image 31 is a graphic prepared beforehand in a specific color, the visibility of the forward direction icon 33 is declined for the operator, if the same color is used in the composed thereto. Accordingly, the forward direction icon 33 is indicated with different color from the symbol image 31. Thereby, the operator can distinguish the forward direction icon 33 clearly.

Although the forward direction icon 33 is depicted in the form of a triangle icon and the apex of the triangle denotes the forward direction, other figure may be used. For example, arrow mark is used for that purpose. Further, when graphic of a handle is adopted to compose on the cab 2 in the symbol image 31, the operator can recognize the forward direction. In any way, arbitral measure can be adopted for clearly indicating the forward direction other than the icon form.

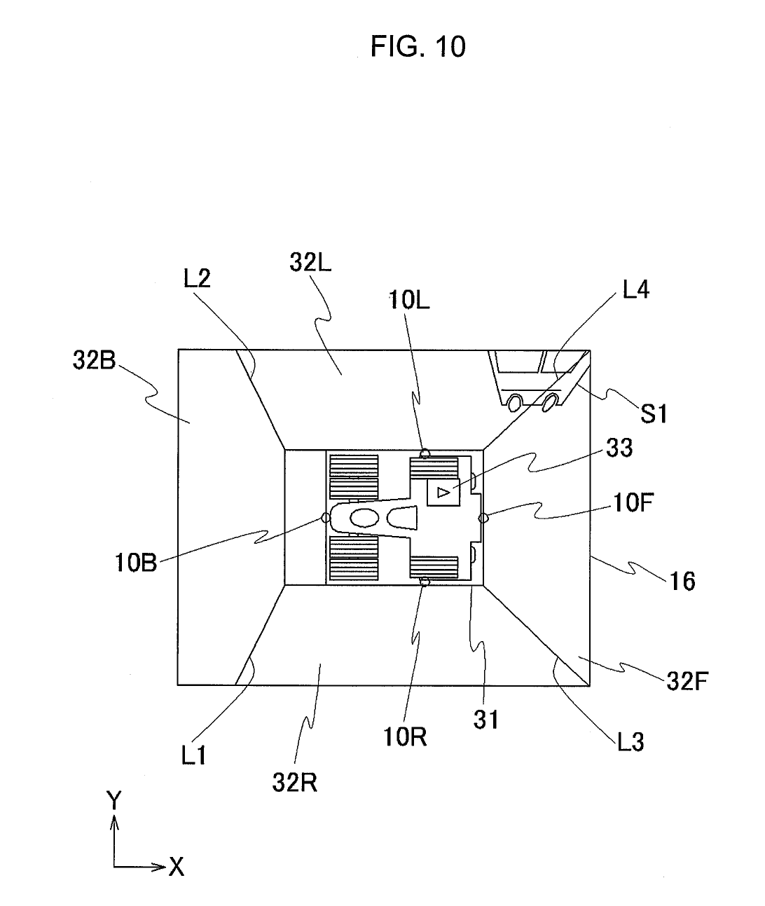

Embodiment shown in FIG. 7 is provided boarder lines L1 to L4 from the corner positions (four corners) of the rectangular shaped region to be displayed the symbol image 31 to the corners of the screen 16, but these may be formed other positions than the corners of the screen 16 as shown in FIG. 10. The boarder lines L1 and L2 are extended apart the positions apart from the corner position in this figure. In a case of displaying rearward side bird's eye view image 32B with high priority, when the rearward side camera 10B has a high pixel density and wide view field. In this connection, the boarder lines L1 and L2 are set depending upon the angle of view, as shown in FIG. 10.

In the next place, following is explanation for processing the image composing section 25 at the time of traveling operation. An operator who is boarded in the cab 2 operates the shift lever 28 for traveling the dump truck 1. As explained above, the shift lever 28 has forward position, neutral position and rearward position, and depending upon the position of the shift lever 28, it is determined as to whether or not traveling the dump truck 1 or not, and the direction when traveling. Information as to the position of the shift lever 28 now entered (shift lever position information) is inputted to the vehicle controller 19, the vehicle controller 19, and the vehicle controller 19 is outputted the shift lever information as a vehicle information to the display controller 18.

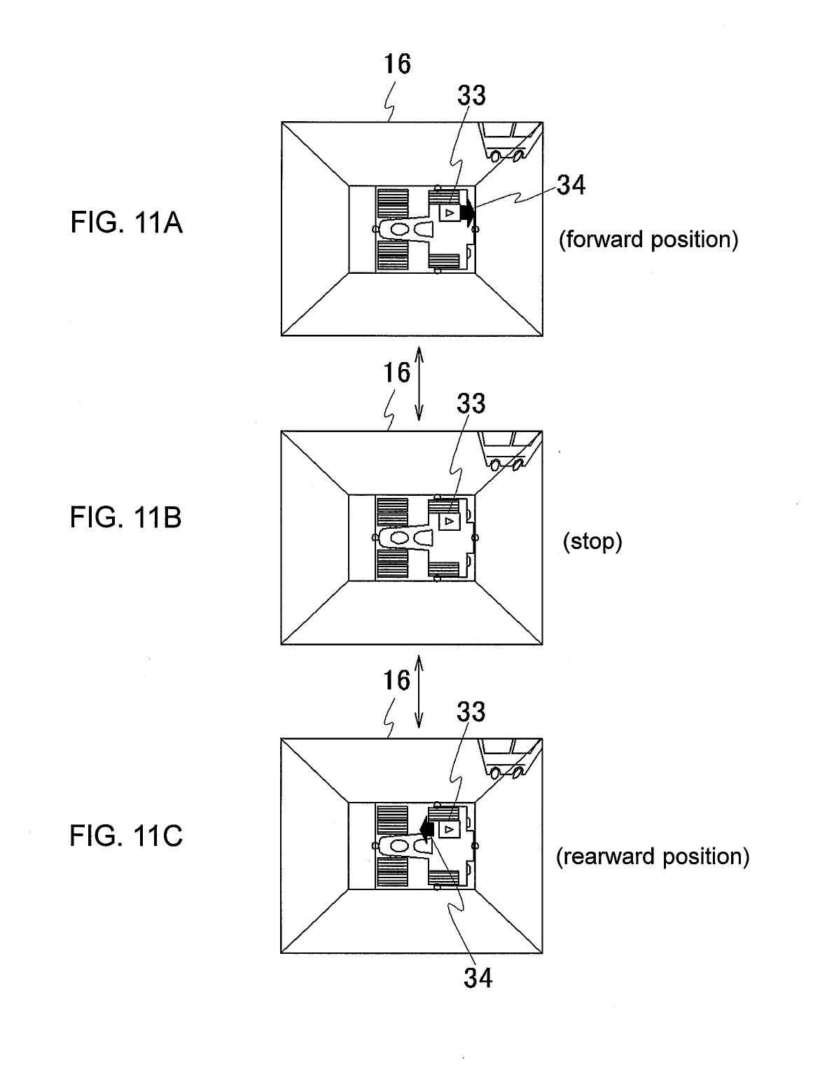

The image composing section 25 obtains the shift lever position information. Thus, the traveling direction of the dump truck is recognized by the image composing section 25. Then, as shown in FIG. 11A, the image composing section 25 is composing a traveling direction icon 34 as a traveling direction indicator on the bird's eye view image, specifically on the symbol image 31, more specifically on the closed position of the forward direction icon 33.

Meanwhile, the dump truck 1 becomes to travel toward direction at the time of the operating the shift lever 28 to forward position by the operator. At this time, the traveling direction icon 34 is represented by the image composing section 25 in accordance with the shift lever position information. Thereby, the traveling direction icon 34 is equivalent to the forward direction icon 33. Thereby, the operator can recognize the forward direction of the symbol image 31 by means of the forward direction icon 33, in addition, ensuring accordingly the dump truck 1 to travel forwardly by the operation of the shift lever 28.

In FIG. 11B is an exemplified display at the time when the shift lever 28 is entered into neutral position. The dump truck 1 does not travel (that is stop). Accordingly, the traveling direction icon 34 is not composed by the image composing section 25. Thus, status that the dump truck 1 is stopped can be known from the screen 16 by not shown the traveling direction icon 34.

In FIG. 11C is an exemplified display at the time when the shift lever 28 is entered into rearward position. In this position, the dump truck 1 travels rearward direction. the traveling direction icon 34 is shown in accordance with the shift lever position information of the image composing section 25. In this situation, the traveling direction icon 34 is shown to reversed direction against the forward direction icon 33. the operator is able to understand the forward direction of the symbol image 31 by the forward direction icon 33, and ensuring accordingly the dump truck 1 to travel rearwardly by the operation of the shift lever 28.

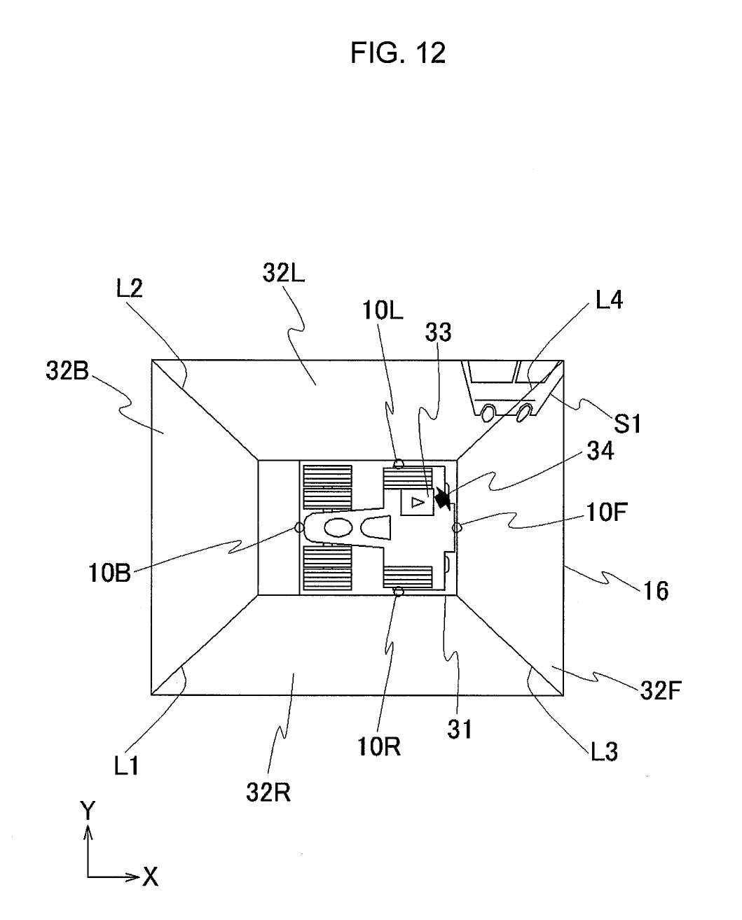

Also, as shown in FIG. 5, steering information is inputted from the handle 11 to the vehicle controller 19, the steering information is further inputted to the image composing section 25. Thereby, the traveling direction toward right or left is recognized during forward traveling or backward traveling based upon shift lever position information and steering information. At this time, the traveling direction icon 34 is changed over as shown in FIG. 12 in accordance with the shift lever position information and steering information. By so constructing, the traveling direction icon 34 can be reflected by the actual traveling direction of the dump truck 1.

The explanation as explained hereinbefore is a example to applied the dump truck 1 as a self-propelled industrial machine, but may be applicable to other self-propelled industrial machine. Although the forward direction is not clearly understood on the basis of only the symbol image 31 in displaying the bird's eye view image, the forward direction of the self-propelled industrial machine can intuitively and precisely recognized by composing the forward direction icon 33.

### DESCRIPTION OF REFERENCE NUMERALS

1: dump truck
2: cab
10: camera
15: monitor
16: screen
16A: split part
16B: split part
18: display controller
19: vehicle controller
21: image correction section
22: view point converting section
23: symbol image storage section
24: forward direction icon composing section
25: image composing section
26: display mode controlling section
27: displaying image creating section
28: shift lever
31: symbol image
32: bird's eye view image
33: forward direction icon
34: traveling direction icon

1. A display device for a dump truck, comprising:
a plurality of cameras having optical axes directed to obliquely downward directions to take images around the dump truck;
a monitor rotatably mounted in an operator's cab of the dump truck; and
a display controller programmed to output images to be displayed to the monitor based on camera images taken by the plurality of cameras,
wherein the display controller is programmed to:
create bird's eye view images in which view points of the camera images taken by the plurality of cameras have been respectively converted to upper view points; and
create a composite bird's eye view image by composing the bird's eye view images around a symbol image in which the dump truck is symbolized, and
wherein the display controller is further programmed to display,
the composite bird's eye view image,
a traveling direction icon which indicates a direction in which the dump truck travels in the composite bird's eye view image; and
a forward direction icon which indicates a forward direction of the dump truck in the composite bird's eye view image,
on the monitor.

2. The display device for a dump truck according to claim 1,
wherein the display controller is further programmed to superpose the traveling direction icon on the symbol image so as to be displayed on the monitor.

3. The display device for a dump truck according to claim 1,
wherein the display controller is further programmed to superpose the forward direction icon on the symbol image so as to be displayed on the monitor.

4. The display device for a dump truck according to claim 3,
wherein the display controller is further programmed to display the forward direction icon on a position which corresponds to the operator's cab in the symbol image.

5. The display device for a dump truck according to claim 1,
wherein the display controller is further programmed not to display the traveling direction icon when the dump truck stops.

6. The display device for a dump truck according to claim 1,
wherein the display controller is further programmed to display the traveling direction icon in color different from color of the symbol image.
